(19) United States
(12) Patent Application Publication
(10) Pub. No.: US 2024/0152942 A1
(43) Pub. Date: May 9, 2024

(54) METHOD FOR AUTOMATED SURVEYING OF HOTEL GUESTS

(71) Applicant: Actinium Consulting AG, Lindau (DE)

(72) Inventor: Klaus HUETTL, Hoerbranz (AT)

(73) Assignee: Actinium Consulting AG, Lindau (DE)

(21) Appl. No.: 18/280,987

(22) PCT Filed: Mar. 9, 2022
(86) PCT No.: PCT/EP2022/056099

§ 371 Date: Sep. 8, 2023

(30) Foreign Application Priority Data
Mar. 16, 2021 (DE) 10 2021 106 320.5

(51) Int. Cl. G06Q 30/0203; G06Q 50/12; H04N 21/475

(52) U.S. Cl. CPC G06Q 30/0203; G06Q 50/12; H04N 21/4758

(57) ABSTRACT

A method for automated surveying of hotel guests uses a television device in the hotel room. The method is executed by an interface measurement circuit for detecting the connection of an external playback device and a video signal switch for switching the signal source to an external television device, a) wherein when the television device is switched on by an external remote control, an external minicomputer sends video data to the video input of the television device via the interface measurement circuit and the video signal switch instead of the data received during normal operation. These video data include a survey software, b) wherein the hotel guest sends the survey answers to the minicomputer via the remote control, c) wherein when the survey is completed, the television device is switched back to normal operation, and d) wherein the survey answers are sent to a hotel server by the minicomputer.

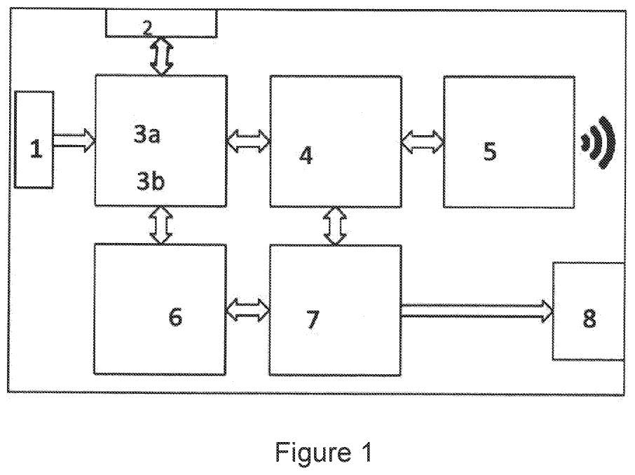

The invention relates to a method for automated solicitation of opinions from hotel guests by means of a television device provided in the hotel room.

### CONCERNING THE PRIOR ART

From US 2014/0 123 186 A1, a hardware for use by hotel guests is known wherein the hardware comprises an infrared interface for reception of the infrared signals of an external TV remote control, a communications module for sending data over the mobile network, a capability for detection of connection of an external playback device, a minicomputer, and a microcontroller having an infrared manager for reception of data from the infrared interface and for output of data to the minicomputer.

No suggestion of a use of the hardware for the automated complaint management in hotels or for automated solicitation of opinions from hotel guests can be found in US 2014/0 123 186 A1.

A “2-Port HDMI® Automatic Switch—4K” device is also known. Herein a rapid and possibly automatic switchover to the last connected HDMI source (auto switching) is described.

The description of that device likewise contains no suggestion of a use of the hardware for the automated complaint management in hotels or for automated solicitation of opinions from hotel guests.

### Task and Accomplishment of the Invention

Task of the invention: The invention is intended to improve the quality of the service in hotels by queries on the television devices in the respective hotel rooms. It permits an automated solicitation of opinions from the guests.

According to the invention, this task is accomplished in the method for automated solicitation of opinions from hotel guests of the type mentioned in the introduction in that the method is executed by means of an interface measuring circuit (6) for detection of connection of an external playback device and of a video signal switchover (7) for switching the signal source over to an external television device,
a) in that, upon switching-on of the television device by means of an external remote control, an external minicomputer (4) sends video data instead of the data received during normal operation to the video input of the television device via the interface measuring circuit (6) and the video signal switchover (7), wherein these video data comprise a survey software, b) in that the hotel guest sends the survey answers via the remote control to the minicomputer (4),
c) in that, after completion of the survey, the television device is switched back over to normal operation and
d) in that the survey answers are sent by the minicomputer (4) to a hotel server.

Advantageous configurations of the invention are listed in the dependent claims.

Thus it is proposed:
that the method be executed by means of a hardware and that the hardware comprise an infrared interface (1) for reception of the infrared signals of the remote control, a SIM module (5) for sending data over the mobile network, and a microcontroller having an infrared manager (3b) for reception of data from the infrared interface (1) and for output of data to the minicomputer (4),
   wherein, upon switching-on of the external television device, the video signal switchover (7) switches the signal source over to the television device,
that the hardware comprise a learning function, in order to be able to learn infrared remote controls of different manufacturers of television devices,
that the infrared manager (3b) be designed to decode the different infrared protocols and to send the necessary data to the minicomputer (4), which saves these,
that the hardware comprise a power manager (3a), which is designed to regulate the powering up and powering down of the minicomputer (4), in order to prevent damage to the file system on the minicomputer (4),
that the hardware be designed to switch the video signal over sometimes by hardware and sometimes by software and, in fact, depending on whether or not the external television device supports a digital protocol.

### EXEMPLARY EMBODIMENT

An exemplary embodiment of the invention will be explained in more detail in the following on the basis of a drawing.

The single FIGURE shows a block diagram of the exemplary embodiment.

### MODE OF OPERATION OF THE METHOD FOR AUTOMATED SOLICITATION OF OPINIONS FROM HOTEL GUESTS BY MEANS OF A TELEVISION DEVICE PROVIDED IN THE HOTEL ROOM

The remote control of the television device is used as the input device. The hardware according to the invention possesses an infrared interface 1, in order to be able to receive the infrared signals of the TV remote control. The hardware possesses a learning function, in order to be able to learn infrared remote controls of numerous manufacturers of television devices. The infrared manager 3b decodes various infrared protocols and sends the necessary data to the minicomputer 4, which saves these. The power manager 3a regulates the powering up and powering down of the minicomputer 4 in order to prevent damage to the file system on the minicomputer 4.

The minicomputer 4 provides a software, in which the communication with the SIM module 5 and the control unit of the video signal switchover 7 is implemented. The software has a graphical user interface, which is sent to the television viewer by means of a video signal. Thereby the hotel guest can be guided on the television device through the survey procedure. After the survey has been completed, the survey data are sent to a server. The sending of the data takes place by means of a SIM module 5, which dispatches the data over the mobile network.

As soon as the television device has been switched on, this is recognized by the hardware, which switches the signal source over to the television device, so that the graphical use interface appears on the screen of the TV device. The detection of whether the television device has been switched on is achieved by hardware and by software. The detection by the hardware is achieved via the interface measuring circuit 6 and the detection by the software via a digital TV interface, which functions as the video signal output 8. The interface measuring circuit 6 sends its measured values to the microcontroller of the power and IR manager 3, so that the measured values can be further processed there.

The switchover of the video signal is achieved sometimes by hardware and sometimes by software. This depends on whether the television device supports a digital protocol, with which the software is able to bring about the switchover of the video signal. Otherwise the video signal is switched over with a hardware module.

### LIST OF REFERENCE SYMBOLS

1 IR receiver
2 Voltage supply
3a Power manager (microcontroller)
3b Infrared manager (microcontroller)
4 Minicomputer
5 SIM module
6 Interface measuring circuit (detection of connection of an external playback device)
7 Video signal switchover
8 Video signal output

1: A method for automated solicitation of opinions from hotel guests by means of a television device provided in the hotel room,
that wherein
the method is executed by means of an interface measuring circuit (6) for detection of connection of an external playback device and of a video signal switchover (7) for switching the signal source over to an external television device,
a) wherein, upon switching-on of the television device by means of an external remote control, an external minicomputer (4) sends video data instead of the data received during normal operation to the video input of the television device via the interface measuring circuit (6) and the video signal switchover (7), wherein these video data comprise a survey software,
b) wherein the hotel guest sends the survey answers via the remote control to the minicomputer (4),
c) wherein, after completion of the survey, the television device is switched back over to normal operation, and
d) wherein the survey answers are sent by the minicomputer (4) to a hotel server.

2: The method according to claim 1,
wherein
the method is executed by means of a hardware and wherein the hardware comprises:
an infrared interface (1) for reception of the infrared signals of the remote control,
a SIM module (5) for sending data over the mobile network, and
a microcontroller having an infrared manager (3b) for reception of data from the infrared interface (1) and for output of data to the minicomputer (4),
wherein, upon switching-on of the external television device, the video signal switchover (7) switches the signal source over to the television device.

3: The method according to claim 2,
wherein
the hardware comprises a learning function, in order to be able to learn infrared remote controls of different manufacturers of television devices.

4: The method according to claim 2,
wherein
the infrared manager (3b) is designed to decode the different infrared protocols and to send the necessary data to the minicomputer (4), which saves these.

5: The method according to claim 2,
wherein
the hardware comprises a power manager (3a), which is designed to regulate the powering up and powering down of the minicomputer (4), in order to prevent damage to the file system on the minicomputer (4).

6: The method according to claim 2,
wherein
the hardware is designed to switch the video signal over sometimes by hardware and sometimes by software and, in fact, depending on whether or not the external television device supports a digital protocol.
